(19) United States
(12) Patent Application Publication
(10) Pub. No.: US 2002/0104732 A1
(43) Pub. Date: Aug. 8, 2002

(54) Electromagnetic clutch

(76) Inventors: Michael A. Ciavaglia, Dearborn, MI (US); Bruce J. Risdon, St. Clair Shores, MI (US)

Correspondence Address: MS. KATHRYN A. MARRA DELPHI TECHNOLOGIES, INC., LEGAL STAFF-M/C:480-414-420, P.O. BOX 5052, TROY, MI, 48007-5052, US

(21) Appl. No.: 10/008,920

(22) Filed: Dec. 6, 2001

Related U.S. Application Data
(60) Provisional application No. 60/267,402, filed on Feb. 7, 2001.

(51) Int. Cl. F16D 27/04

(52) U.S. Cl. 192/84.951; 310/232

(57) ABSTRACT

An electromagnetic clutch has a spool that houses an internal coil winding and that has a drive member attached to it. A molded plastic carrier cap is fitted onto an axial end of spool. Carrier cap has two thin, axially spaced slip rings that are secured to a peripheral wall of the carrier cap. The two slip rings are connected to input and output ends respectively of the coil winding. Coil winding is energized from a direct current source by stationery brush assemblies that are radially oriented and circumferentially spaced from each other. Each brush assembly includes a brush contact that is spring biased into contact with one of the slip rings. A plate rotor that has a drive member attached to it is next to the opposite axial end of the spool.

This patent application claims priority of Provisional Patent Application No. 60/267,402 filed Feb. 7, 2001.

### FIELD OF THE INVENTION

This invention relates generally to electromagnetic clutches and more particularly to electromagnetic clutches with a rotating magnetic field.

### BACKGROUND OF THE INVENTION

Electromagnetic clutches with rotating fields are already known. These electromagnetic clutches include a nonconductive carrier with two radially spaced, flat, concentric slip rings fastened to an annular face of the carrier. The slip rings have leads soldered to them that are bent with the bent ends connected to input and output ends of the clutch coil. Two axially oriented brush assemblies have brush contacts engaging the respective slip rings to energize the clutch coil. Such an electromagnetic clutch is satisfactory for many purposes. However, the space requirements in the axial direction due to the axially oriented brush assemblies prevent use of the electromagnetic clutch in narrow spaces. Moreover, the size of the drive gear that is attached to the spool of the clutch coil for rotation with the spool cannot exceed the inner diameter of the flat inner slip ring due to the presence of the axially oriented brush assembly for the inner slip ring. Thus the size of the drive gear is restricted by the radial or lateral space available for the flat outer slip ring.

### SUMMARY OF THE INVENTION

This invention provides an electromagnetic clutch that is compact in the axial direction and that has slip rings that do not restrict the size of the drive gear.

The electromagnetic clutch of the invention has a rotatable spool that houses an internal coil winding that has two coil terminals. The spool carries two axially spaced slip rings along a peripheral wall of the rotatable spool. The slip rings are connected to the two coil terminals respectively. Two stationery brushes that are radially oriented and circumferentially spaced from each other have brush contacts that are spring biased into contact with the respective slip rings. This configuration reduces space requirements in the axial direction and allows a larger drive gear.

The slip rings are preferably attached to a molded carrier cap that is filled to an end of the spool. The slip rings are also preferably connected to the coil terminals by integral terminal tabs that are bent over an end face of the carrier cap and connected to the coil terminals by separate conductor wires. The terminal tabs and conductor wires are preferably protected by an end cap that fits over the end of the carrier cap.

### BRIEF DESCRIPTION OF THE DRAWINGS

FIG. 1 is a perspective view of an electromagnetic clutch of the invention;

FIG. 2 is a section of the electromagnetic clutch taken substantially along the line 2-2 of FIG. 1 looking in the direction of the arrows;

FIG. 3 is a section of the electromagnetic clutch taken substantially along the line 3-3 of FIG. 1 looking in the direction of the arrows; and

FIG. 4 is a section of the electromagnetic clutch taken substantially along the line 4-4 of FIG. 1 looking in the direction of the arrows.

### DETAILED DESCRIPTION OF A PREFERRED EMBODIMENT

Electromagnetic clutch 10 comprises a spool 12 that is rotatably mounted in a housing (not shown). Spool 12 houses an internal coil winding 14 and includes a internal passage 16 that receives a drive member 17 that includes a drive gear 18. Drive member 17 is keyed to spool 12 for rotation with the spool.

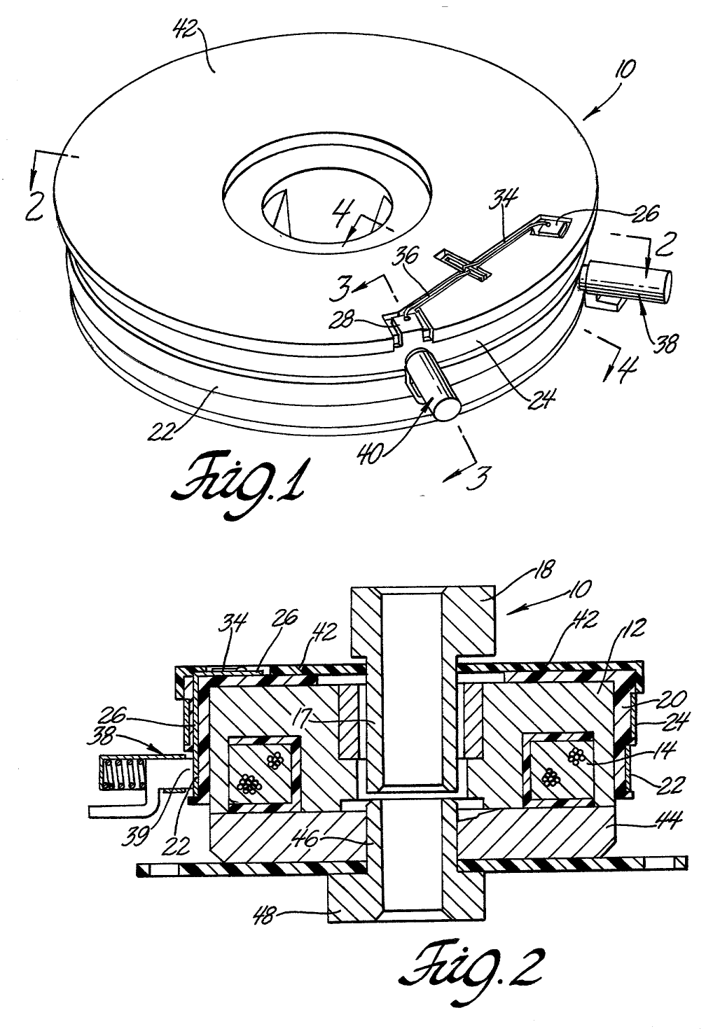

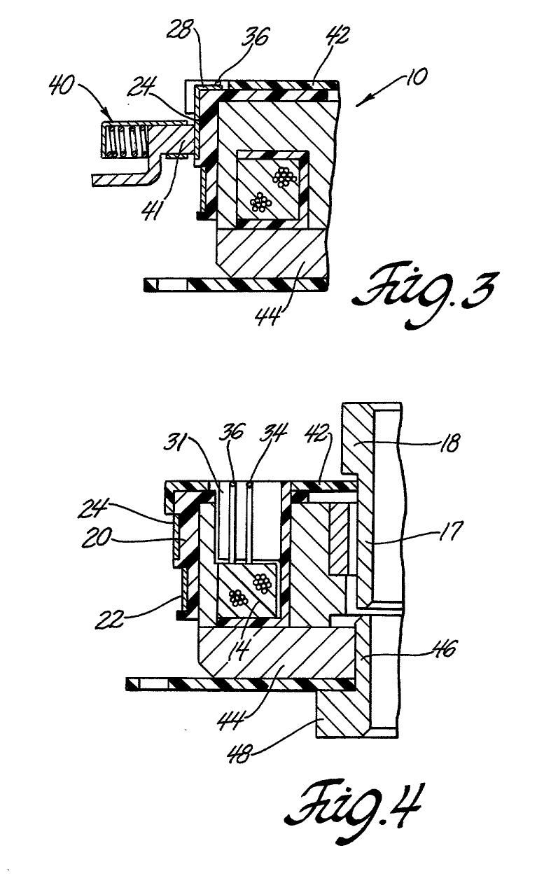

A molded plastic carrier cap 20 is fitted onto an axial end of spool 12. Carrier cap 20 has two, thin, concentric slip rings 22 and 24 secured to a peripheral wall of the carrier cap. Slip rings 22 and 24 are axially spaced and electrically insulated from each other by carrier cap 20. Slip ring 22 includes an integral terminal tab 26 that is partially embedded in spool 12 and bent over an end face of spool 12 as best shown in FIGS. 1 and 2. The outer diameter of slip ring 22 is preferably spaced radially inwardly of the inner diameter of slip ring 24 to facilitate the partial embodiment of terminal tab 26. Slip ring 24 likewise has an integral terminal tab 28 that is bent over the end face of spool 12 as best shown in FIGS. 1 and 3.

Terminal tabs 26 and 28 are connected to input and output ends of coil winding 14 respectively by separate conductor wires 34 and 36 as best shown in FIGS. 1 and 4. Coil winding 14 is energized by a direct current source, such as a vehicle battery (not shown), through stationery brush assemblies 38 and 40 that are radially oriented and circumferentially spaced from each other by the housing for spool 12 (not shown). Brush assembly 38 has a brush contact 39 that is spring biased into engagement with slip ring 22 that has terminal tab 26 that is connected to one end of coil winding 14 by conductor wire 34. Brush assembly 40 has a brush contact 41 that is spring biased into engagement with slip ring 24 that has terminal tab 28 that is connected to the other end of coil winding 14 by conductor wire 36.

Electromagnetic clutch 10 preferably includes a protective end cap 42 on top of carrier cap 20 to protect tab terminals 26 and 28 and conductor wires 34 and 36 as best shown in FIG. 1. Electromagnetic clutch also includes a metal rotor plate 44 that is rotatably mounted in the housing (not shown) next to the opposite end face of spool 12. Rotor plate 44 has a bore that receives a drive member 46 that includes a drive gear 48.

Electromagnetic clutch 10 operates as follows. Assume that drive gear 48 is an input that is conventionally driven by an electric motor or other rotary power (not shown). This drives drive plate 44. However, drive gear 18 which in this case is the output may or may not be driven. If the coil winding 14 is not energized, then drive gear 18 remains stationery. However, if coil winding 14 is energized then coil winding 14 creates a magnetic field that couples spool 12 to rotor plate 44. Spool 12 then rotates with rotor plate 44 creating a rotating magnetic field that is constantly energized via brush contacts 39 and 41 and slip rings 22 and 24. Spool 12 in turn rotates drive gear 18. Drive gear 12 can be stopped by stopping input gear 48 or simply deenergizing coil winding 14 by opening a conventional circuit switch (not shown).

While the operation has been explained with drive gear 48 as the input and drive gear 18 as the output, it is also possible for drive gear 18 to be the input and drive gear 48 to be output. In this latter case, drive gear 48 is selectively driven by energizing coil winding 14.

Electromagnetic clutch 10 is very compact in the axial direction because slip rings 22 and 24 are axially oriented and axially spaced rather than radially oriented and radially spaced and because brush assemblies 38 and 40 are radially oriented rather than axially oriented. Moreover, the axial orientation of slip rings 22 and 24 and the radial orientation of brushes 38 and 40 does not limit the size of drive gear 18.

We claim:

1. An electromagnetic clutch comprising:
a rotatable spool that houses an internal coil winding and that includes a internal passage for attaching a drive member having a drive gear;
the coil winding having first and second ends,
a molded plastic carrier cap that is fitted onto an axial end of the spool,
the carrier cap having thin, concentric slip rings that are secured to a peripheral wall of the carrier cap so the slip rings are axially spaced and insulated from each other by the carrier cap,
one of the slip rings having an outer diameter that is radially spaced inwardly of an inner diameter of another of the slip rings and that includes a first integral terminal tab that is partially embedded in the spool and bent over an end face of spool, the first integral terminal tab being connected to the first end of the coil winding by a first conductor wire,
the another of the slip rings having a second integral terminal tab that is bent over the end face of spool, the second integral terminal tab being connected to the second end of the coil winding by a second conductor wire,
first and second stationery brush assemblies that are radially oriented and circumferentially spaced from each other,
the first stationery brush having a first brush contact that is spring biased into contact with one of the slip rings, and
the second stationery brush having a second brush contact that is spring biased into contact with another of the slip rings.

2. The electromagnetic clutch as defined in claim 1 further including an end cap on top of carrier cap to protect the first and second terminal tabs and the conductor wires connecting the terminal tabs to the first and second ends of the coil winding.

3. The electromagnetic clutch as defined in claim 1 further including a rotor plate at the opposite end face of spool and a drive member attached to the rotor plate.

4. An electromagnetic clutch comprising:
a rotatable spool that houses an internal coil winding and that includes a internal passage for attaching a drive member;
the coil winding having first and second ends,
a molded plastic carrier cap that is fitted onto an axial end of the spool,
the carrier cap having thin, concentric slip rings secured to a peripheral wall of the carrier cap so that the slip rings are axially spaced and electrically insulated from each other,
one of the slip rings being connected to the first end of the coil winding and another of the slip rings being connected to the second end of the coil winding,
first and second stationery brush assemblies that are radially oriented and circumferentially spaced from each other,
the first stationery brush having a first brush contact that is spring biased into contact with the first slip ring, and
the second stationery brush having a second brush contact that is spring biased into contact with the second slip ring.

5. The electromagnetic clutch as defined in claim 4 further including a protective end cap on top of carrier cap.

6. The electromagnetic clutch as defined in claim 4 further including a rotor plate at the opposite end face of spool and a drive member attached to the rotor plate.

7. An electromagnetic clutch comprising:
a rotatable spool that houses an internal coil winding and that includes a drive member attached to the rotatable spool.;
the coil winding having first and second ends,
first and second axially spaced slip rings carried by the rotatable spool along a peripheral wall of the rotatable spool,
one of the slip rings being connected to the first end and another of the slip rings being connected to the second end,
first and second stationery brush assemblies that are radially oriented and circumferentially spaced from each other,
the first stationery brush assembly having a first brush contact that is spring biased into contact with the first slip ring, and
the second stationery brush assembly having a second brush contact that is spring biased into contact with the second slip ring.
